(19) United States
(12) Patent Application Publication
(10) Pub. No.: US 2009/0266466 A1
(43) Pub. Date: Oct. 29, 2009

(54) COATING FILM TRANSFER METHOD AND TOOL

(75) Inventors: Tsutomu Yamamoto, Tokyo (JP); Masahiko Ono, Osaka-shi (JP)

Correspondence Address: HOWSON & HOWSON LLP, 501 OFFICE CENTER DRIVE, SUITE 210, FORT WASHINGTON, PA, 19034, US

(73) Assignee: FUJICOPIAN CO., LTD., Osaka-shi, Osaka-fu (JP)

(21) Appl. No.: 12/306,052

(22) PCT Filed: Jun. 21, 2007
(86) PCT No.: PCT/JP2007/062956

§ 371 Date: Feb. 9, 2009

(30) Foreign Application Priority Data
Jun. 23, 2006 (JP) 2006-174270

(51) Int. Cl. B32B 37/02

(52) U.S. Cl. 156/60; 156/436

(57) ABSTRACT

A gluing tool, one of the embodiments of a coating film transfer tool, comprises a supply reel 20 which supplies a coating film transfer tape 10 composed of a base tape and a coating film attached thereon, a transfer roller 30, a take-up reel 40 which rolls up the base tape after transfer, a cooperative drive mechanism 50 which is adapted to cause said reels to rotate cooperatively, and a pressing roller 60. When a receiving object P, being pressed onto the transfer roller 30 by the pressing roller 60, is moved, the coating film is transferred only over the range in which the receiving object P was moved. The coating film remained unused can be utilized by rewinding the transfer tape 10.

### FIELD OF THE INVENTION

This invention relates to a coating film transfer method and tool for transferring coating films like adhesive onto a receiving surface by moving not the apparatus or the tool but the receiving objects such as labels, envelopes, and the like.

### BACKGROUND ART

Examples of conventional coating film transfer methods and tools include an adhesive transferring method disclosed in Unexamined Japanese Patent Publication No. 2311/2001, which is to bind a book by having the adhesive transferred onto a predetermined side of printed materials, and a transfer tool disclosed in Unexamined Japanese Patent Publication No. 319619/2005, by which a coating film is transferred onto a receiving surface across its full width.

### DISCLOSURE OF THE INVENTION

However, the transferring method disclosed in the publication No. 2311/2001 cannot be used for documents other than a specific type of printed materials, because the adhesive is transferred onto a predetermined side of printed materials and cannot be transferred to different parts.

With the transfer tool of the publication No. 319619/2005, a coating film is transferred onto a receiving surface across its full width. Therefore, it lacks user-friendliness in that it requires users to look for and reset a coating film transfer tape with appropriate width depending on the size of a receiving object.

Moreover, if a user intends to have the adhesive transferred onto a receiving object with various width, he/she is unable to replace the tape without a tape with corresponding width, which results in receiving objects not covered with the adhesive over the whole surface. Thus, the tool left a problem in that receiving objects get partially strained or result in disfigurement due to detachment of portions without the adhesive.

In view of the above problems, the object of the present invention is to provide a coating film transfer method and tool which is capable of having adhesive transferred over any width and for any length as intended, and with which adhesive and the like can be transferred onto a desired portion for the length needed.

The present invention solved the above-mentioned problems with a coating film transfer method using a supply reel which supplies a coating film transfer tape composed of a base tape and a coating film attached thereon, a take-up reel which rolls up the base tape after transfer, and a cooperative drive mechanism which is adapted to cause said reels to rotate cooperatively:

characterized in that a receiving object, being pressed under said coating film, is moved to have said coating film transferred only over the range in which said receiving object was moved.

Further, the present invention provides a coating film transfer tool to embody the above-mentioned transfer method comprising a supply reel which supplies a coating film transfer tape composed of a base tape and a coating film attached thereon, a take-up reel which rolls up the base tape after transfer, and a cooperative drive mechanism which is adapted to cause said reels to rotate cooperatively:

characterized in that the tool has a means to keep said coating film being pressed on a receiving object and a means to move said receiving object; and

said coating film is transferred only over the range in which said receiving object was moved.

A coating film transfer tape can be utilized more efficiently by making a roller to press a receiving object and a table from materials with releaseability and by making the transfer tape rewindable.

The roller and the table can also gain releaseability on the surface with a film being attached thereto, which has releaseability on its surface and adhesiveness or adhesion on the other side. In this way, if releaseability of the surface is impaired, it can be regained easily and at low cost.

The transfer method and tool of this invention have an advantage that it does not require a user to prepare many types of coating film transfer tapes with various width, because it can be used for any type of receiving objects including printed materials and labels, and adhesives and other coating films can be transferred over any width and for any length as intended.

Further, a coating film can be easily transferred onto the whole surface of a receiving object to be covered by the coating film, by using a relatively wide coating film transfer tape. Moreover, a coating film transfer tape can be efficiently utilized, because the coating film transfer tape which is left with partially remained coating film can be rewound so as to have the remaining coating film transferred onto other receiving objects.

Furthermore, with a transfer tape which has substantially the same width with or is wider than a receiving object, a coating film can be transferred steadily onto a wide sealing part of an envelope without deviation, simply by pulling the envelope not in the width direction but in the length direction.

### BRIEF DESCRIPTION OF DRAWINGS

FIG. 1 illustrates a first embodiment of the present invention, in which (a) is a schematic front view, (b) is a right side view, and (c) is a schematic front view of a receiving object being held between a supply reel and a pressing roller, and (d) is a plane view of a receiving object after transfer.

FIG. 2 is a perspective view of a second embodiment of the present invention.

FIG. 3 is a front view of a third embodiment of the present invention.

FIG. 4 is a top view of a forth embodiment of the present invention, illustrated in a partially broken condition.

FIG. 5 is a front view of a forth embodiment of the present invention.

### PREFERRED EMBODIMENTS OF THE INVENTION

Referring to the drawings, embodiments of this invention are to be described hereafter.

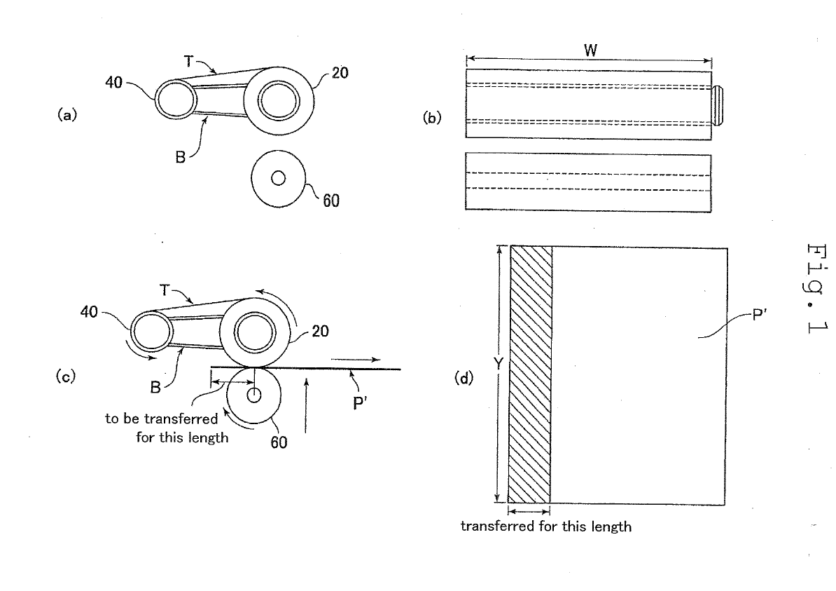

FIG. 1 illustrates a first embodiment of the present invention. This embodiment is to be described as an example which uses a transfer tape with approximately the same width with a receiving object. FIG. 1(a) is a schematic front view, FIG. 1(b) is a right side view, and FIG. 1(c) is a schematic front view of a receiving object being held between a supply reel and a pressing roller, and FIG. 1(d) is a plane view of a receiving object after transfer.

The following is an example of how to use a glue tape, or an adhesive transfer tape wherein an adhesive layer is coated on a base tape, to seal an envelope. As is shown in FIGS. 1(b) and 1(c), with a glue tape which has width W substantially the same width with width Y of a sealing part of an envelope P′, a receiving object, the adhesive can be transferred onto the intended part with one pull without deviation, by simply moving the receiving object P′, being sandwiched between a supply reel 20 and a pressing roller 60, in the direction of the arrow in FIG. 1(c). Thus, the present invention is especially useful for sealing envelopes.

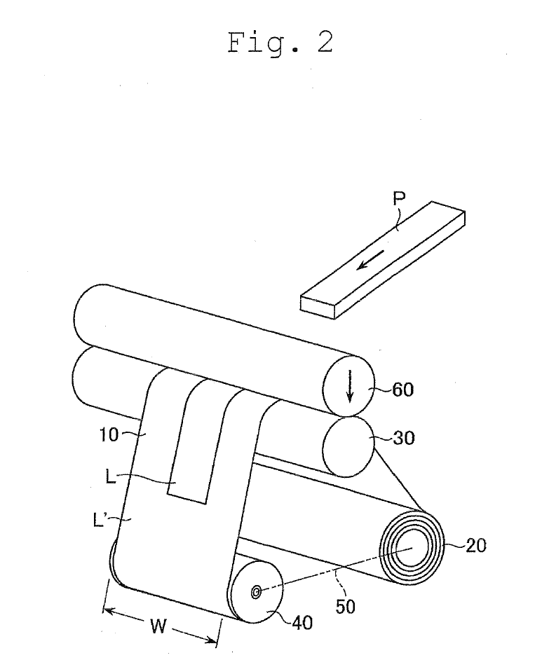

FIG. 2 shows a second embodiment of the present invention.

The second embodiment is to be described as a gluing tool.

The tool comprises a supply reel 20 which has a roll of an adhesive transfer tape 10 therearound wherein an adhesive layer is coated on a base tape, and which has shafts formed on both ends thereof rotatably supporting the reel, and a transfer roller 30 to press down the adhesive transfer tape 10 unreeled from the supply reel 20 on the back side of the receiving object P so as to transfer the adhesive onto the back side of the receiving object P, which also has shafts (not shown in the Figure) formed on both ends thereof rotatably supporting the roller.

The tool further comprises a take-up reel 40 on the surface of which an end of the base tape after transfer is attached, and which also has shafts formed on both ends thereof rotatably supporting the reel, and a cooperative drive mechanism 50 to cooperatively drive the supply reel 20 and the take-up reel 40 in the same rotational direction. Examples of the cooperative drive mechanism include gear-type and belt-type ones etc. which are generally known to those skilled in the art, and hence details are not to be described.

The tool is further provided with a pressing roller 60 which is arranged to sandwich the adhesive transfer tape 10 and the receiving object P on the outer surface of the transfer roller 30, and which is an elastic member so as to be pressed against the transfer roller 30. The surface of the pressing roller 60 is made from resin which has so-called “releaseability,” so that the adhesive remained around the receiving object P does not stick to the pressing roller 60. The pressing roller 60 is also rotatably supported on both ends, and a handle or a knob to turn the roller (not shown in the Figure) can be provided on either end.

The transfer roller 30 and the pressing roller 60 compose a means to keep a coating film being pressed against a receiving object P.

The pressing roller 60, which also works as a driving means for the receiving object P, can be rotated either backward or forward. Therefore, the adhesive transfer tape 10, which is left with the adhesive without being transferred onto the receiving object P, can be rewound to have the adhesive coating film transferred onto other receiving objects P with a narrow receiving part. The reels and the rollers are supported within a casing (not shown in the Figure) by shafts and bearings which are generally known to those skilled in the art.

To have the adhesives transferred onto the receiving object P, the receiving object P is inserted between the transfer roller 30 and the pressing roller 60 with the receiving surface being faced to the transfer roller 30. When the handle (not shown in the Figure) of the pressing roller 60 is turned around to move the receiving object P in the direction of the arrow, the transfer roller 30 is pressed to rotate, having the adhesive transfer tape 10 unreeled from the supply reel 20, and the take-up reel 40 is also caused to rotate by means of the cooperative drive mechanism 50 to roll up the base tape after transfer. Thus, the adhesive is transferred onto the receiving object P by the distance it was moved.

More specifically, when the width W of the adhesive transfer tape is 96 mm, for example, the adhesive can be transferred across this width, which means, with the receiving object P having the width of for instance 30 mm, the adhesives can be transferred onto not only one but two or three receiving objects P at a time. The receiving object P would receive the adhesive over its whole surface with no part without the adhesive.

The base tape after transfer is left with transferred parts L without adhesives which was transferred onto the receiving object P and a part L′ with adhesives left without being transferred. However, the adhesives can be prevented from being transferred onto the pressing roller 60 by coating the surface of the pressing roller 60 with fluorine resin, silicon resin and the like, or producing it from foamed objects.

With this method, the pressing roller need not be turned around 360 degrees or more, but can be rotated by specific degrees within a certain range, thereby enabling a user to have the adhesive transferred onto a limited area or a corner of the receiving object P. The receiving object itself can be moved manually.

Since the releaseability of the surface of the pressing roller 60 may get degraded due to rubbing with receiving objects as the transfer tool is used repetitively, it is desirable that the surface can be easily replaced. Specifically, a functional film, wherein adhesive materials are layered on one side thereof and materials with releaseability are layered on the other side (see, for example, Unexamined Japanese Patent Publication No. 95073/1998), can be attached on the surface of the pressing roller 60, which is to be replaced when the releaseability get degraded. Thus, releaseability can be easily regained without replacing the transfer tool as a whole.

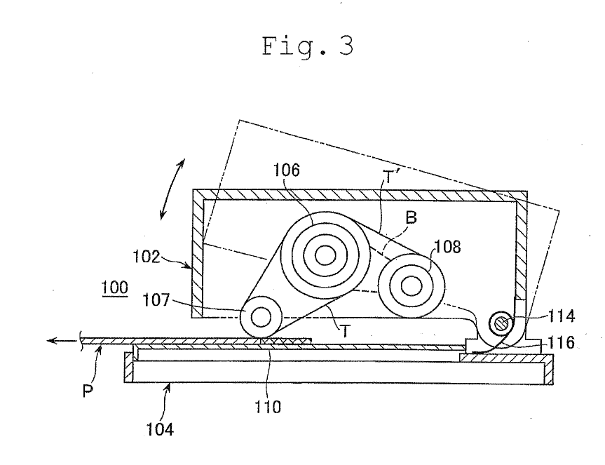

FIG. 3 illustrates a third embodiment of this invention. This coating film transfer tool 100 comprises transfer tool main body 102 on the upper side and a base body 104 on the downside.

The transfer tool main body 102 comprises a supply reel 106 having a glue tape (a coating film for gluing) T therearound, a take-up reel 108 which rolls up a base tape T′ after the glue was transferred onto a receiving object P from the unreeled glue tape T, and a transfer roller 107 to transfer a coating film onto the receiving object P, all of which are, as is generally known, rotatably supported by bearings (not shown in the Figure) provided within the transfer tool main body 102. The supply reel 106 and the take-up reel 108 are adapted to rotate cooperatively with each other by means of a belt B.

On the other hand, the base body 104 on the downside is provided with a table 110 to place a receiving object P thereon. The surface of this table 110, which also works as a means to move the receiving object P, should be made from adhesive and releaseable materials.

As is discussed in the case of the second embodiment, in view of the fact that the table will gradually lose adhesiveness and releaseability on the surface due to rubbing with receiving objects at the time of transfer, it is desirable to employ a special film like those mentioned above as a material for the surface, thereby enabling a user to easily replace it.

The transfer tool main body 102 on the upper side and the base body 104 on the downside are joined on one end by means of a hinge assembly 114, wherein the transfer tool main body 102 on the upper side is normally raised up by a twisted coil spring 116, as is shown in an imaginary line in FIG. 3.

This coating film transfer tool 100 is used as follows;

This tool can be used in a similar way as for relatively large-size staplers.

The first step is to place a receiving object P on the table 110, setting a receiving part right under the transfer roller 107.

Then the transfer tool main body 102 in a raised-up position is pressed down over the receiving object P by means of the hinge assembly 114 to sandwich the receiving object P between the transfer roller 107 and the table 110.

In this embodiment, the transfer roller 107 and the table 110 compose a means to keep the coating film being pressed on the receiving object P.

When the receiving object P is pulled in the direction of the arrow, it slides on the table 110 with good adhesiveness and releaseability. Thus, the receiving object P receives the glue on the surface in contact with the transfer roller 107.

In FIG. 3, the glue tape, a coating film, is transferred onto the cross-hatched part of the receiving object P.

However, without any mark on the surface of the table 110, users have no way of knowing where the tool starts gluing. Accordingly, a guide line for setting a receiving object P should be desirably marked on the surface of the table 110.

When the receiving part of the receiving object P is narrower than the width of the glue tape T, the glue tape T is left with parts in which the glue remains without being transferred.

As in a forth embodiment to be mentioned below, the supply reel 106 can be rotated inversely by a knob (not shown in the Figure) to rewind the glue tape T after transfer and have the remained glue transferred onto other receiving object P, which leads to efficient utilization of the remaining glue.

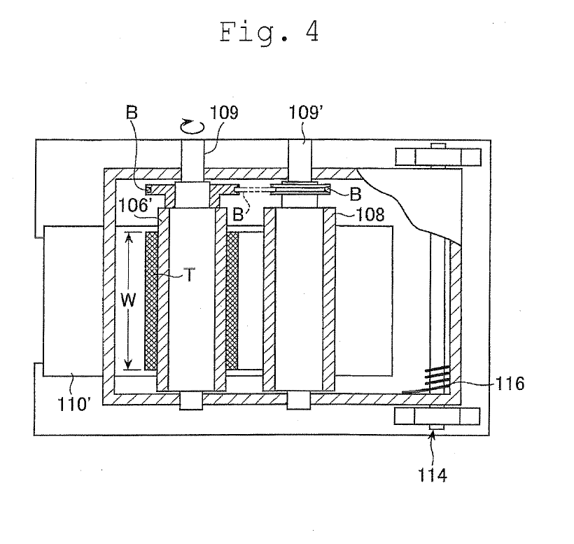

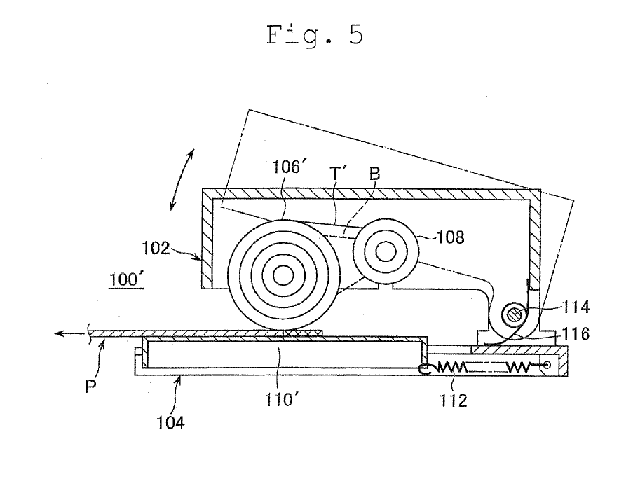

FIGS. 4 and 5 illustrates the forth embodiment of the present invention. In this coating film transfer tool 100′, a supply reel also works as a transfer roller, and only two members, a transfer roller-cum-supply reel 106′ and a take-up reel 108, are rotatably supported by U-shaped grooves provided at four points on both of inner side plates of the transfer tool main body 102. Accordingly, it has an advantage of having a simpler structure compared to the tool of the third embodiment. The transfer roller-cum-supply reel 106′ can be inversely rotated by a knob 109. It can be provided on the take-up reel 108 as a knob 109′.

The base body 104 on the downside, on the other hand, has a movable table 110′ to place a receiving object P thereon, which can be moved in the direction rectangular to the width direction of the glue tape T and is adapted to return to the initial position by an extension coil spring 112.

The transfer tool main body 102 on the upper side and the base body 104 on the downside are joined on one end by means of a hinge assembly 114, wherein the transfer tool main body 102 on the upper side is normally raised up by a twisted coil spring 116, as is shown in an imaginary line in FIG. 5.

This tool can be used basically in the same way as in the third embodiment, but with some differences, because the table 110′ is not fixed but movable.

The first step is to place a receiving object P on the movable table 110′, setting a receiving part right under the transfer roller-cum-supply reel 106′.

Then, as in the third embodiment, the transfer tool main body 102 in a raised-up position is pressed down over the receiving object P by means of the hinge assembly 114 to sandwich the receiving object P between the transfer roller-cum-supply reel 106′ and the movable table 110′.

In this embodiment, the transfer roller-cum-supply reel 106′ and the movable table 110′ compose a means to keep the coating film being pressed on the receiving object P.

As the receiving object P is pulled in the direction of the arrow together with the movable table 110′ (which also works as a means to move the receiving object P), it receives the glue on the surface in contact with the transfer roller-cum-supply reel 106′.

When the receiving object P held between the transfer roller-cum-supply reel 106′ and the movable table 110′ is pulled out, the glue is transferred to the end of the receiving object P, where the receiving object P is drawn apart from the glue tape T, thereby cutting the glue.

In FIG. 5, the glue tape is transferred onto the cross-hatched part of the receiving object P.

When the receiving part of the receiving object P is narrower than the width of the glue tape T, the glue tape T is left with parts in which the glue remains without being transferred.

To transfer those remaining glue, the transfer roller-cum-supply reel 106′ can be rotated inversely by a knob 109 to rewind the glue tape T after transfer and have the remained glue transferred onto other receiving objects P, which leads to efficient utilization of the remaining glue.

In this forth embodiment, the surface of the movable table 110′ need not be adhesive; only necessary feature is releaseability from glue.

It may be obvious for those skilled in the art that the outer shell of the transfer tool main body 102 can be made transparent or provided with a notch/notches to help users easily recognize a guideline for the point right under the transfer roller.

### INDUSTRIAL APPLICABILITY

The transfer tool of the present invention can be used for any type of receiving objects including printed paper and labels, and adhesives and other coating films can be transferred over any width and for any length as intended. Accordingly, the present invention can provide a transfer method and tool which does not require a user to prepare many types of coating film transfer tapes with various width.

Further, a coating film can be easily transferred onto the whole surface of a receiving object to be covered by the coating film, by using a relatively wide coating film transfer tape. Moreover, a coating film transfer tape can be efficiently utilized, because the coating film transfer tape which is left with partially remained coating film can be rewound so as to have the remaining coating film transferred onto other receiving objects.

Furthermore, with a transfer tape which has substantially the same width with or is wider than a receiving object, a coating film can be transferred steadily onto a wide sealing part of an envelope without deviation, simply by pulling the envelope not in the width direction but in the length direction.

What is claimed is:

1. A coating film transfer method using a supply reel which supplies a coating film transfer tape composed of a base tape and a coating film attached thereon, a take-up reel which rolls up the base tape after transfer, and a cooperative drive mechanism which is adapted to cause said reels to rotate cooperatively: characterized in that a receiving object, being pressed under said coating film, is moved to receive said coating film only over the range in which said receiving object was moved.

2. A coating film transfer tool comprising a supply reel which supplies a coating film transfer tape composed of a base tape and a coating film attached thereon, a take-up reel which rolls up the base tape after transfer, and a cooperative drive mechanism which is adapted to cause said reels to rotate cooperatively: characterized in that the tool has a means to keep said coating film being pressed on a receiving object and a means to move said receiving object; and said coating film is transferred only over the range in which said receiving object was moved.

3. A coating film transfer tool as claimed in claim 2, wherein said coating film transfer tape has substantially the same width as or is wider than said receiving object.

4. A coating film transfer tool as claimed in claim 2, wherein a means to keep said coating film being pressed on a receiving object is composed of a transfer roller and a pressing roller.

5. A coating film transfer tool as claimed in claim 2, wherein a means to keep said coating film being pressed on a receiving object is composed of a transfer roller and a movable table.

6. A coating film transfer tool as claimed in claim 2, wherein a means to keep said coating film being pressed on a receiving object is composed of a transfer roller and a table having a surface with adhesiveness and releaseability.

7-10. (canceled)

11. A coating film transfer tool as claimed in claim 4, wherein said pressing roller or said movable table has releaseability on the surface.

12. A coating film transfer tool as claimed in claim 5, wherein said pressing roller or said movable table has releaseability on the surface.

13. A coating film transfer tool as claimed in claim 2, wherein the surface of said pressing roller, said table, or said movable table has a replaceable functional film.

14. A coating film transfer tool as claimed in claim 3, wherein the surface of said pressing roller, said table, or said movable table has a replaceable functional film.

15. A coating film transfer tool as claimed in claim 4, wherein the surface of said pressing roller, said table, or said movable table has a replaceable functional film.

16. A coating film transfer tool as claimed in claim 5, wherein the surface of said pressing roller, said table, or said movable table has a replaceable functional film.

17. A coating film transfer tool as claimed in claim 6, wherein the surface of said pressing roller, said table, or said movable table has a replaceable functional film.

18. A coating film transfer tool as claimed in claim 7, wherein the surface of said pressing roller, said table, or said movable table has a replaceable functional film.

19. A coating film transfer tool as claimed in claim 2, wherein said supply reel also works as a transfer roller.

20. A coating film transfer tool as claimed claim 2, wherein said coating film transfer tape can be rewound from said take-up reel to said supply reel.
